(19) United States
(12) Patent Application Publication
(10) Pub. No.: US 2024/0286918 A1
(43) Pub. Date: Aug. 29, 2024

(54) NANOPARTICLES AND PROCESS OF PRODUCING SAME

(71) Applicant: DREXEL UNIVERSITY, Philadelphia, PA (US)

(72) Inventors: Michel W. BARSOUM, Moorestown, NJ (US); Hussein Osama BADR, Philadelphia, PA (US); Tarek Aly ELMELIGY, Philadelphia, PA (US)

(21) Appl. No.: 18/572,309

(22) PCT Filed: Jun. 23, 2022
(86) PCT No.: PCT/US2022/073121

§ 371 Date: Dec. 20, 2023

Related U.S. Application Data
(60) Provisional application No. 63/214,660, filed on Jun. 24, 2021.

(51) Int. Cl. C01G 23/00; B82Y 40/00

(52) U.S. Cl. CPC C01G 23/00; B82Y 40/00; C01P 2002/01; C01P 2002/72; C01P 2004/64

(57) ABSTRACT

Processes of producing nanoparticles from solid phase precursor non-nanoparticles. Contacting a solid phase precursor non-nanoparticle selected from oxides of metals and metalloids, carbides of metals and metalloids, nitrides of metals and metalloids, borides of metals and metalloids, silicides of metals and metalloids, and phosphides of metals and metalloids, and mixtures thereof, with one or more onium ions in water in a vessel. Some processes can be one pot processes. The vessel is agitated and held at temperature for a time sufficient to form nanoparticles with the same crystalline structure as the solid phase precursor non-nanoparticle as determined by XRD and/or TEM. Nanoparticles made by the processes. Processes of use of the nanoparticles.

### CROSS REFERENCE TO RELATED APPLICATIONS

The present application claims priority to and the benefit of U.S. patent application No. 63/214,660, “Nanoparticles and Process of Producing Same” (filed Jun. 24, 2021), the entirety of which application is incorporated herein by reference for any and all purposes.

### GOVERNMENT RIGHTS

This invention was made with government support under Contract No. 1740795 awarded by the National Science Foundation. The government has certain rights in the invention.

### TECHNICAL FIELD

The present disclosure relates generally to the field of nanomaterials, and more specifically to nanoparticles and processes of producing and using same.

### BACKGROUND

Specific synthesis processes are employed to produce the various nanoparticles, coatings, dispersions, or composites. Two basic strategies are used to produce nanoparticles: ‘top-down’ and ‘bottom-up’.

In the ‘bottom-up’ strategy, structures are built up by chemical processes. Bottom-up methods are based on physicochemical principles of molecular or atomic self-organization. Gas phase processes (aerosol processes) typically require flame-, plasma-, laser—or hot wall reactors, yielding products such as fullerenes and carbon nanotubes. These processes either require high temperatures (1200-2200° C.) and/or very low pressures (vacuum). The wet-chemical synthesis of nanomaterials typically takes place at lower temperatures than gas phase synthesis but are nonetheless complicated processes. In the precipitation of solids from a metal ion-containing solution, metal oxides as well as non-oxides or metallic nanoparticles can be produced. The process is based on reactions of salts in solvents. A precipitating agent is added to yield the desired particle precipitation, and the precipitate is filtered out and thermally post-treated. Temperature, pH value of the solution, the sequence in which the source materials are added, and mixing processes can influence reaction kinetics.

Nanoreactors, such as microemulsions, bubbles, micelles, and liposomes, are known. They are composed of a polar group and a non-polar hydrocarbon chain. Microemulsions require at least one tenside (substance that reduces the surface tension of liquids) while at the same time preventing particle agglomeration, which can be difficult. Zeolites (microporous aluminum-silicon compounds) are produced from aqueous superheated solutions in autoclaves (airtight pressure chambers). The partial vaporization of the solvent creates pressure in the autoclaves (several bars), triggering chemical reactions that differ from those under standard conditions, for example by altering the solubility.

In sol-gel processes, material production or deposition takes place through a complicated series of steps from a liquid sol state, which is converted into a solid gel state via a sol-gel transformation. The sol-gel transformation involves a three-dimensional cross-linking of the nanoparticles in the solvent, whereby the gel takes on bulk properties. A controlled heat treatment in air can transform gels into a ceramic oxide material. To start with, adding organic substances in the sol-gel process produces an organometallic compound from a solution containing an alkoxide (metallic compound of an alcohol, for example with silicon, titanium, or aluminum). The pH value of the solution is adjusted with an acid or a base which, as a catalyst, also triggers the transformation of the alkoxide.

The subsequent reactions are hydrolysis (splitting of a chemical bond by water) followed by condensation and polymerization. The course of hydrolysis and the polycondensation reaction depend on many factors: the composition of the initial solution, the type and amount of catalyst, temperature as well as the reactor—and mixing geometry. In all cases, gel formation is followed by a drying step. One disadvantage of the sol-gel process lies in the difficult-to-control synthesis and drying steps, which complicate scaling up the process. Moreover, organic contaminants can remain in the gel. The resulting necessary cleaning steps, drying and thermal posttreatment makes this production process more complex than gas phase synthesis.

One disadvantage of the wet-chemical synthesis of nanomaterials is that the desired crystalline shapes often cannot be produced, and that the thermal stability of the product powder may be lower, requiring thermal post-treatment. An advantage is that the liquid phase enables highly porous materials to be produced; this would normally not be possible in gas phase reactors due to the high temperatures.

It would be an advance in nanoparticle production if processes could be developed exhibiting improvements related to cost, either in energy efficiency, starting materials, or both, particularly for producing nanoparticles from relatively low cost, normally solid chemical compositions, and avoid potentially unsafe temperature and pressure conditions.

### SUMMARY

In accordance with the present disclosure, nanoparticles, and processes of producing same are described which reduce or overcome many of the faults of previously known processes.

A first aspect of the present disclosure are processes comprising (or consisting essentially of, or consisting of):
a) contacting a solid phase precursor, which is optionally a non-nanoparticle, selected from oxides of metals, oxides of metalloids, carbides of metals, carbides of metalloids, nitrides of metals, nitrides of metalloids, borides of metals, borides of metalloids, phosphides of metals, phosphides of metalloids, silicides of metals, silicides of metalloids, and mixtures thereof, with one or more onium ions (e.g. an ammonium ion) derived from one or more onium salts, in water (in certain embodiments deionized water) in a vessel with sufficient agitation and at a temperature and for a time period sufficient to form a nanoparticles, the temperature ranging from about 0° C. to about 100° C. (or from about 25° C. to about 95° C., or from about 30° C. to about 90° C., or from about 35° C. to about 80° C.) for a time period of at least 10 minutes, (or ranging from about 1 to about 200 hrs., or from about 10 to about 190 hrs., or from about 12 to about 192 hrs., or from about 24 to about 144 hrs., or from about 48 to about 96 hrs.);
b) optionally contacting the nanoparticles of part (a) with an organic solvent (for example, an alcohol, an ether, or mixture thereof) to remove excess water;
c) optionally contacting the nanoparticles of part (b) with an inorganic salt solution (e.g. 1 M LiCl) to form further cleansed nanoparticles; and
d) optionally filtering and drying the nanoparticles of part (c) to form dried nanoparticles.

Without being bound to any particular theory or embodiment, a nanoparticle according to the present disclosure can comprise a 1 Da (i.e., a 1-dimensional anatase material). The 1 Da can also be termed a quat-derived nanomaterial (QDN).

A 1 Da can comprise an oxide-based nanofilament and/or subnanofilament, and can optionally comprise an amount of carbon. (As described herein, a nanofilament can comprise, e.g., titanium.) The composition can be present as a mesoporous powder in which the powder particulates comprise the oxide-based nanofilaments and/or subnanofilaments. The 1 Da composition can be present in the form of flakes, e.g., 2D bodies formed (e.g., via self-assembly) of 1 Da filaments. The 1 Da composition can also be present as 3D bodies, e.g., nanoparticles.

A 1 Da can exhibit a XRD pattern that, when compared to a XRD pattern of nano- or bulk anatase, exhibit reduced (104) and (105) peaks at around 38° and about 55° two theta (2θ). 1 Da nanofilaments and/or subnanofilaments can, in some embodiments, exhibit a Raman spectrum that is quite similar to that of bulk anatase, but can differ from bulk anatase in terms of the XRD spectrum, as described herein.

An 1 Da can be obtained by reacting starting materials (e.g., MAX-phase materials, carbides, nitrides, borides, sulfides, metals, and the like) with an onium salt (such as ammonium salts, TMAOH, TBAOH, TPAOH), e.g., at a temperature of from room temperature to 100° C. under ambient pressure. The admixture can optionally include an ammonium salt. An 1 Da can, as mentioned, be present as a 2D material, but this is not a requirement, as the 1 Da can also be present as a nanoparticle, a nanoribbon, nanowhiskers, nanotubes, a 1D material (e.g., fibers), or in other form.

In certain processes the metals of the oxides, nitrides, carbides, silicides, borides, and phosphides can be selected from one or more transition metals, the elements in Groups 3-12 of the Periodic Table, or mixtures and combinations thereof. In certain embodiments the transition metals can be selected from one or more of V, Nb, Mn, and Ti, and mixtures and combinations thereof. In certain embodiments the metals can be selected from one or more alkaline earth metals and mixtures and combinations thereof, for example, but not limited to, Mg. In certain embodiments the metalloid can be Si, but other metalloids (B, As, Ge, Sb, P, and Te) are considered within the present disclosure. In some cases, a metalloid and a non-metal, e.g., Si₃N₄.

A second aspect of the present disclosure is nanoparticles produced from the processes of the first aspect of the present disclosure. Certain products of the processes of the first aspect comprise the same chemical formula as the solid phase precursor. The final composition of the nanoparticles is the same as the composition of the solid phase precursor non-nanoparticles.

As used herein, “composition” refers to the types of constituent atoms of the solid phase precursor non-nanoparticles and the product nanoparticles. This does not mean, however, that the ratio of atoms remains constant when comparing the solid phase precursor non-nanoparticles and the nanoparticles; in fact, we have evidence that it does change. Moreover, in all embodiments the crystalline structure of the nanoparticles (as determined by X-ray diffraction, or XRD and/or transmission electron microscopy, or TEM) remains the same as the crystalline structure of the solid phase precursor non-nanoparticles.

This does not mean, however, that the XRD peaks of the solid phase precursor non-nanoparticles and the XRD peaks of the nanoparticles are necessarily identical in shape. For example, the XRD peaks of the nanoparticles can be broader than the corresponding XRD peaks of the solid phase precursor non-nanoparticles. The solid phase precursor non-nanoparticles simply shrink in size to the nanoparticle scale.

“Nanoparticles” can comprise, consist essentially of, or consist of nanoparticles of the same structure as determined by XRD. For example, nanoparticles can comprise a minor portion (e.g., less than 50 percent) of a non-nanomaterial; nanoparticles can consist essentially of nanoparticles and trace amounts (up to 5 percent, or up to 2 percent, or up to 0.1 percent) of non-nanomaterials, for example water, organic solvent, or other solid non-nanomaterials that do not detract from the properties of the nanoparticles, or mixtures and combinations thereof; and nanoparticles can consist of nanoparticles (and only nanoparticles). In certain process embodiments, washing the nanoparticles with mild acids, such as HCl, can remove other reaction products, such as metal-carbide-oxides (MCOs) which are sometimes produced at the same time as the nanoparticles. We have discovered that HCl, for example, dissolves the MCO but not the nanoparticles, so production of substantially pure nanoparticles is possible using processes of the present disclosure.

A third aspect of the present disclosure is an apparatus for carrying out the processes of the first aspect of the present disclosure.

Processes of using one or more nanoparticles of the present disclosure are also presented, such as property enhancement fillers in polymeric materials, and biomedical applications, for example, but not limited to, cancer treatment.

Processes of making and using nanoparticles, apparatus, systems, and the nanoparticles of the present disclosure will become more apparent upon review of the brief description of the drawings, the detailed description of the disclosure, and the claims that follow.

### BRIEF DESCRIPTION OF THE DRAWINGS

In the drawings, which are not necessarily drawn to scale, like numerals can describe similar components in different views. Like numerals having different letter suffixes can represent different instances of similar components. The drawings illustrate generally, by way of example, but not by way of limitation, various aspects discussed in the present document. In the drawings:

FIG. 1 is a schematic process flow diagram of one process and system embodiment in accordance with the present disclosure;

FIG. 2 is a more detailed schematic process flow diagram of another process and system embodiment in accordance with the present disclosure;

FIG. 3 is an illustrative diagram of a process in accordance with the present disclosure.

FIG. 4 is an illustrative diagram of a process in accordance with the present disclosure.

FIG. 5A is a photograph of an illustrative, non-limiting laboratory experiment and illustrative, non-limiting nanoparticles produced according to the present disclosure.

FIG. 5B is a photograph of an illustrative, non-limiting laboratory experiment and illustrative, non-limiting nanoparticles produced according to the present disclosure.

FIG. 6A is a photograph of an illustrative, non-limiting laboratory experiment and illustrative, non-limiting nanoparticles produced according to the present disclosure.

FIG. 6N is a photograph of an illustrative, non-limiting laboratory experiment and illustrative, non-limiting nanoparticles produced according to the present disclosure.

FIG. 7A is a photograph of an illustrative, non-limiting laboratory experiment and illustrative, non-limiting nanoparticles produced according to the present disclosure.

FIG. 7B is a photograph of an illustrative, non-limiting laboratory experiment and illustrative, non-limiting nanoparticles produced according to the present disclosure.

FIG. 8 is a powder XRD graph of a nanoparticle sample produced according to the present disclosure.

FIG. 9 is a powder XRD graph of a nanoparticle sample produced according to the present disclosure.

FIG. 10 is a powder XRD graph of a nanoparticle sample produced according to the present disclosure.

FIG. 11 is a powder XRD graph of a nanoparticle sample produced according to the present disclosure.

FIG. 12 is a powder XRD graph of a nanoparticle sample produced according to the present disclosure.

FIG. 13 is a powder XRD graph of a nanoparticle sample produced according to the present disclosure.

FIG. 14 is a powder XRD graph of a nanoparticle sample produced according to the present disclosure.

FIG. 15 is a powder XRD graph of a nanoparticle sample produced according to the present disclosure.

FIG. 16 is a powder XRD graph of a nanoparticle sample produced according to the present disclosure.

FIG. 17 is a powder XRD graph of a nanoparticle sample produced according to the present disclosure.

FIG. 18 is a powder XRD graph of a nanoparticle sample produced according to the present disclosure.

FIG. 19 is a powder XRD graph of a nanoparticle sample produced according to the present disclosure.

### DETAILED DESCRIPTION OF ILLUSTRATIVE EMBODIMENTS

The present disclosure may be understood more readily by reference to the following detailed description of desired embodiments and the examples included therein.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing. All publications, patent applications, patents and other references mentioned herein are incorporated by reference in their entirety. The materials, methods, and examples disclosed herein are illustrative only and not intended to be limiting.

The singular forms “a,” “an,” and “the” include plural referents unless the context clearly dictates otherwise.

As used in the specification and in the claims, the term “comprising” can include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any impurities that might result therefrom, and excludes other ingredients/steps.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

Unless indicated to the contrary, the numerical values should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently of the endpoints. The endpoints of the ranges and any values disclosed herein are not limited to the precise range or value; they are sufficiently imprecise to include values approximating these ranges and/or values.

As used herein, approximating language can be applied to modify any quantitative representation that can vary without resulting in a change in the basic function to which it is related. Accordingly, a value modified by a term or terms, such as “about” and “substantially,” may not be limited to the precise value specified, in some cases. In at least some instances, the approximating language can correspond to the precision of an instrument for measuring the value. The modifier “about” should also be considered as disclosing the range defined by the absolute values of the two endpoints. For example, the expression “from about 2 to about 4” also discloses the range “from 2 to 4.” The term “about” can refer to plus or minus 10% of the indicated number. For example, “about 10%” can indicate a range of 9% to 11%, and “about 1” can mean from 0.9-1.1. Other meanings of “about” can be apparent from the context, such as rounding off, so, for example “about 1” can also mean from 0.5 to 1.4. Further, the term “comprising” should be understood as having its open-ended meaning of “including,” but the term also includes the closed meaning of the term “consisting.” For example, a composition that comprises components A and B can be a composition that includes A, B, and other components, but can also be a composition made of A and B only. Any documents cited herein are incorporated by reference in their entireties for any and all purposes.

Moreover, the use of negative limitations is specifically contemplated; for example, certain compositions, apparatus, systems, and processes can comprise a number of physical components and features, but can be devoid of certain optional chemical species, hardware and/or other features. For example, certain nanoparticle embodiments can be devoid of components that are not compatible with nanoparticles. Certain nanoparticle compositions can be devoid of MCOs. Certain apparatus embodiments can comprise vessels devoid of any gaskets or O-rings, or welds or threaded fittings. In certain embodiments the solid precursor non-nanoparticle material can be devoid of anything but metal oxides.

As explained elsewhere herein, most bottom-up processes to produce nanoparticles are either gas-phase or liquid-phase, with gas-phase typically requiring high temperatures and low pressures, and liquid-phase processes requiring complicated processing with many steps. All these factors add tremendously to the capital and operating costs, and especially with high temperatures and low pressures the possibility of accidents.

The following aspects and embodiments thereof are illustrative only and do not limit the scope of the present disclosure or the appended claims.

A first aspect of this disclosure are processes comprising (or consisting essentially of, or consisting of):
a) contacting a solid phase precursor non-nanoparticle selected from oxides of metals, oxides of metalloids, carbides of metals, carbides of metalloids, nitrides of metals, nitrides of metalloids, borides of metals, borides of metalloids, sulfides of metals, sulfides of metalloids, phosphides of metals, phosphides of metalloids, silicides of metals, silicides of metalloids, and mixtures and combinations thereof, with one or more onium ions derived from one or more onium salts (e.g. an ammonium salt) in water in a vessel with sufficient agitation and at a temperature and for a time period sufficient to form nanoparticles, the temperature ranging from about 0° C. to about 100° C. (or from about 25° C. to about 95° C., or from about 30° C. to about 90° C., or from about 35° C. to about 80° C.) for a time period of at least 10 minutes, (or ranging from about 1 to about 200 hrs., or from about 10 to about 190 hrs., or from about 12 to about 192 hrs., or from about 24 to about 144 hrs., or from about 48 to about 96 hrs.);
b) optionally contacting the nanoparticles of (a) with an organic solvent (for example, an alcohol, an ether, or mixture thereof) to remove excess water);
c) optionally contacting the nanoparticles of (b) with an inorganic salt precipitation solution (e.g. 1 M LiCl); and
d) optionally filtering and drying the nanoparticles of (c) to form dried nanoparticles.

In certain embodiments, the “metal” (sometimes referred to herein as simply “M”) can be at least one metal selected from the group consisting of Group 2 (alkaline earth metals), Groups 3-12 (transition metals), and combinations and mixtures thereof. In certain embodiments, the metal is at least one metal selected from the group consisting of Ti, Mn, Ni, Fe, and Mg, and combinations and mixtures thereof. In certain embodiments, the metal is at least one metal selected from the group consisting of Ti and Mg, and combinations and mixtures thereof.

In certain embodiments, the metal can be at least one Group 4 metal, for example, Ti, Zr, and Hf, and combinations and mixtures thereof. In certain process and composition embodiments, the metal is at least one Group 5-12 metal, for example, but not limited to V, Cr, Mn, Co, Ni, Cu, Zn, Y, Zr, Nb, Mo, Tc, Ru, Rh, Pd, Ag, Cd, Hf, Ta, W, Re, Os, Ir, Pt, and Au, and combinations and mixtures thereof. In certain process and composition embodiments, metal can be at least one Group 8 metal. In certain process embodiments, M is at least one Group 8 metal. In certain process embodiments, M can be at least one Group 4 metal. In certain process embodiments, M is at least one Group 4 metal. In certain process embodiments, M can be at least one Group 2 alkaline earth metal. In certain process embodiments, M is at least one Group 2 alkaline earth metal.

In certain embodiments, the metalloid (sometimes referred to herein as simply (“MD”) can comprise one or more MDs selected from the group consisting of B, Si, Ge, As, Sb, Te, P, and S, and combinations and mixtures thereof. In certain embodiments, MD is one or more metalloids selected from the group consisting of Si and Ge, and combinations and mixtures thereof. In certain embodiments, MD can comprise Si and one or more of B, Ge, As, Sb, Te, S and P, and combinations and mixtures thereof. In certain embodiments, MD is a mixture or combination of Si and one or more of B, Ge, As, Sb, Te, P, and S, and combinations and mixtures thereof. In certain embodiments, MD can comprise Si and any one or more of B and Ge, and combinations and mixtures thereof. In certain embodiments, metals can be bound to any one or more reactive nonmetals (C, O, N, F, P, S, Cl, Se, Br, and I). In certain embodiments, metalloids can be bound to any one or more reactive nonmetals (C, O, N, F, P, S, Cl, Se, Br, and I).

Another aspect of the present disclosure are nanoparticles prepared according to the processes of the present disclosure. Certain process embodiments can use precursor non-nanomaterial(s) at least some of which have an anatase structure. Certain process embodiments can result in at least some of the nanoparticles having an anatase-like or rutile-like structure. Certain process embodiments can use solid phase precursor non-nanomaterial(s) at least some of which have an anatase-like or rutile-like structure, and result in forming nanoparticles, at least some of the nanoparticles having an anatase-like or rutile-like structure.

Certain processes can be carried out at temperature ranging from about 0° C. to about 100° C., or from about 25° C. to about 95° C., or from about 30° C. to about 90° C., or from about 35° C. to about 80° C., and for a time period of at least 10 minutes, or ranging from about 1 to about 200 hrs., or from about 10 to about 190 hrs., or from about 12 to about 192 hrs., or from about 24 to about 144 hrs., or from about 48 to about 96 hrs. In certain process embodiments the nanoparticles are produced using a so-called “one pot” process (synthesis carried out in a single reaction container or vessel); in other words, the contacting of the solid phase precursor non-nanoparticle with the one or more onium ions derived from one or more onium salts, in water, for the times, temperature, and pressures indicated herein, produces the nanoparticles directly in one vessel, without any further changes and/or steps taught by the prior art.

Certain processes can be carried out at pressures ranging from sub-atmospheric to above atmospheric, or from vacuum or near-vacuum pressure to several bar, or from atmospheric pressure to 10 bar, or from about 1 bar to about 5 bar.

The nanoparticles of the present disclosure can be conducting, non-conducting, semiconducting, porous, mesoporous (such as described in U.S. Pat. No. 9,562,005), or non-porous, where “porous” includes mesoporous porosities and porosities above mesoporous, “non-porous” means porosity less than mesoporous, and “mesoporous” refers to porous materials having an average pore size in the range from about 2 to about 50 nanometers (nm).

### Solid Phase Precursor Non-Nanoparticles

The solid phase precursor non-nanoparticles function as a source of metal (M) or metalloid (MD) and one or more reactive non-metals, for example, but not limited to O, C, B, S, P, Si, and N atoms, and combinations thereof, to produce the nanoparticles. Suitable solid phase precursor non-nanoparticles can be binary, ternary, quaternary or higher materials. The binary material can be, for example, but to limited to TiC, TiB₂, TiN, Ti₅S₃, TiAl₃, TiO₂, MnB, MgO, Si₃N₄, CoO, Fe-oxides such as, but not limited to Fe₂O₃, Mn₃O₄, MnO₂, FeB, ZrC, Si₃N₄, SiC, and any combinations and mixtures thereof. Suitable other solid phase precursor non-nanoparticles can be ternary M-containing or ternary MD-containing materials. The ternary M-containing and/or MD-containing materials can be, for example, but not limited to Ti₃AlC₂, Ti₃SiC₂, Ti₃GaC₂, Ti₂SbP, Mn₅SiB₂, Mn₂AlB₂, Fe₅SiB₂, Fe₂AlB₂, Zr₃AlC₅, V₂AlC, Nb₂AlC, and combinations and mixtures thereof.

### Onium Cations and Salts Thereof

Without being bound to any particular theory, the onium salt (or its cation and/or anion) functions to chemically react with at least a portion of the solid phase precursor non-nanoparticles to induce formation of the nanoparticles. The name onium is also used for cations that would result from the substitution of hydrogen atoms in those ions by other groups, such as organic radicals, or halogens; such as tetraphenylphosphonium, (C₆H₅)₄P+. The substituent groups can be divalent or trivalent, yielding ions such as iminium and nitrilium. The onium ion of the onium salt can have a charge of +1, +2 (a double onium), +3 (a triple onium) and even larger.

The onium cation can have monovalent substitutions or polyvalent substitutions. Suitable examples of monovalent substituted onium cations include, but are not limited to, primary onium cations within the formula RH₃N+(such as NH₃OH+), secondary onium cations within the formula R₂NH₂+(such as (CH₃)₂NH₂+), tertiary onium cations within the formula R₃NH+(such as (CH₃)₃NH+), and quaternary onium cations within the formula R₄N+, where R in these formulas can be organic or inorganic moieties. Enium cations, substituted enium cations, and ynium cations are considered with the present disclosure as well, with the substitution being organic or inorganic.

In certain embodiments, the onium ion can be derived from one or more onium salts, for example an ammonium salt. Suitable ammonium salts include, but are not limited to, tetramethylammonium hydroxide (TMAOH), tetraethylammonium hydroxide (TEAOH), tetrapropylammonium hydroxide (TPAOH), tetrabutylammonium hydroxide (TBAOH), ammonium hydroxide (NH+OH), tetrahexylammonium hydroxide (THAOH), their amine derivatives, and combinations and mixtures thereof.

In other embodiments, the onium salt can be based on protonated pnictogens, protonated chalcogens, or protonated halogens. Examples of pnictogen onium cations include NH₄⁺ (ammonium), PH₄⁺ (phosphonium), AsH₄⁺ (arsonium), SbH₄⁺ (stibonium), and BiH₄⁺ (bismuthonium). Examples of chalcogen onium cations include (H₃O⁺ (oxonium), H₃S⁺ (sulfonium), H₃Se⁺ (selenonium), and H₃Te⁺ (telluronium). Examples of halogen onium cations include H₂F⁺ (fluoronium), H₂Cl⁺ (chloronium), H₂Br⁺ (bromonium), and H₂I⁺ (iodonium). Examples of pseudohalogen onium cations include H₂N₃⁺ (aminodiazonium) and HCNH⁺ (either HC≡CH⁺ isomer, or C≡CH₂⁺ isomer, or both). Suitable carbon group onium cations include carbonium ions, for example, but not limited to alkanium cations, CₙH2ₙ₊₃⁺ (for example, but not limited to CH₅⁺ (methanium), C₂H₇⁺ (ethanium), C₃H₉⁺ (propanium, which can be either propan-1-ylium isomer, or propan-2-ylium isomer, or both), C₄H₁₁⁺ (butanium, one or more isomers, or combination of two or more isomers), C₈H₁₉⁺ (octonium, one or more isomers, or combination of two or more isomers), SiₙH₂ₙ₊₃⁺ (silaniums), germoniums such as GeH₅⁺, stannoniums such as SnH₃⁺, and plumboniums such as PbH₃⁺. Other suitable onium cations include BH₄⁺ (boronium cation) and protonated boranes of the formula BₓH_{y}⁺; noble gas onium cations, such as HeH⁺ (helonium), NeH⁺ (neonium), ArH⁺ (argonium), KrH⁺ (kryptonium), XeH⁺ (xenonium); and H₃⁺ (hydrogenonium, or trihydrogen cation).

In certain embodiments the onium ion can be selected from diquats, aliquats, polyquats, and other forms. Examples of diquats include, but are not limited to didodecyl dimethyl-gamma-diquaternium salts, N-dodecyl propylenediamine gamma-diquaternium bromide, and the like. Examples of aliquats include, but are not limited to N-Methyl-N,N,N-trioctylammonium chloride (known as Aliquat 336), tetrabutylammonium bromide (known as Aliquat 100), methyltri-n-butylammonium chloride (known as Aliquat 175), and the like. Examples of polyquats include, but are not limited to Ethanol, 2,2′,2″-nitrilotris-, polymer with 1,4-dichloro-2-butene and N,N,N′,N′-tetramethyl-2-butene-1,4-diamine (also known as polyquaternium-1), Poly[bis(2-chloroethyl) ether-alt-1,3-bis[3-(dimethylamino)propyl]urea] (known as polyquaternium-2), and the like (polyquaternium-X, where X ranges from 1 to 47 or higher, the number designating the order of registration under the International Nomenclature of Cosmetic Ingredients, assigned in accordance with rules established by the Personal Care Products Council (PCPC).

In certain process embodiments, the onium salt can be accompanied by one or more oxidizing agents, for example, but not limited to, H₂O₂, halogens, such as fluorine (F₂), chlorine (Cl₂), and bromine (Br₂), and certain oxy anions, such as the permanganate ion (MnO₄⁻) and the dichromate ion (Cr₂O₇²⁻), and mixtures and combinations thereof.

In embodiments employing one or more oxidizing agents, the molar ratio of onium salt to oxidizing agent can range from about 5:1 to about 1:5, or from about 4:1 to about 1:4, or from about 3:1 to about 1:3, or from about 2:1 to about 1:2.

In certain embodiments the onium cation will be present in water, with the anion being the hydroxyl anion OH⁻, however, the anion of the onium salt is not limited to hydroxyl anion, and could be any organic or inorganic moiety, such as, but not limited to halogen anions (Fl⁻, Cl⁻ and the like), complex halogen anions (for e.g., [FeBr₄]⁻, and the like.

### Organic Solvents

Organic solvents, if used, function to wash or cleanse the nanoparticles and remove excess water. The organic solvent can remove some or all of, for example, but not limited to non-reacted solid phase precursor materials, unreacted ammonium cations and anions, non-dissolved ammonium salts, and the like. Suitable organic solvents include liquid oxygenated hydrocarbons such as, but not limited to, alcohols, glycol ethers, and ketones. Examples of suitable alcohols include compounds such as, but not limited to, ethyl alcohol (or ethanol), propyl alcohol (or propanol), n-butyl alcohol, and t-butyl alcohol. Suitable glycol ethers include, but are not limited to, ethylene glycol ether and propylene glycol ether. Suitable hydrocarbon solvents include pentane, hexane, heptane, octane, benzene, and mixtures and combinations thereof. Normal, branched, and cyclic versions are included in these examples. Halogenated hydrocarbons solvents such as chlorobenzene, iodobenzene, and the like can also be suitable. Polar aprotic solvents such as dimethylformamide (DMF) can also be used alone, in combination with other polar aprotic solvents, or in mixtures and combinations with any of the above.

### Inorganic Salt Solutions

Inorganic salt solutions, if used, also function to wash or cleanse the nanoparticles and remove excess water and/or dissolve other reaction products (but not the nanoparticles). Suitable inorganic salt solutions include, but are not limited to, solutions of salts of alkali metals and halogens, such as, but not limited to LiCl, NaCl, and LiBr, and mixtures of any two or more of these, in molarities ranging from 0.001 up to 10 M. HCl and other mild acids like citric, and the like, can be used at similar molarity ranges.

### Centrifuging and Filtering Equipment

Once formed in the vessel, in certain embodiments the nanoparticles are centrifuged (and/or ultracentrifuged) one or more times until a clear supernatant is formed, then filtered. Suitable centrifuging techniques are well known and require little explanation. Bench-top and floor-standing centrifuges are available from companies such as Fisher Scientific, Eppendorf, Beckman Coulter and others. Commercial scale centrifuges, such as disc stack centrifuges, are available from companies such as Alfa Laval. Suitable filtering techniques include gravity filtration and vacuum filtration. Suitable commercial-scale filtration units can include rotary vacuum filters, chilling filters based on a refrigerant, and the like.

### Vessels

Suitable vessels for use in processes of the present disclosure can be continuous, semi-continuous, batch or semi-batch reactors. When the onium ion is derived from TMAOH, we have found polyethylene vessels (polyethylene, or polyethylene-lined vessels) to be effective, but not glass or glass-lined metal vessels. Glass or glass-lined steel (or PTFE, or PFA, or tantalum) vessels can be usable in certain embodiments (for example with onium salts other than TMAOH). The vessel volumes can range from lab-scale (50 mL) up to commercial scale (10,000 L or more), and can include accessories, for example, but not limited to, pressure and temperature measurement devices, agitation devices, motors for running the agitators, one or more inlets and outlets for inert gas purging, heating and cooling facilities, timers, and one or more human/machine interfaces (HMIs). Certain vessels can include one or more process controllers, pressure relief valves, accessways for human or non-human inspection, sampling ports, pH probes, and the like. Suitable vessels should have the capability to withstand temperatures up to 200° C. and up to 2 bar pressure for up to 250 hours or more.

### Inert Gases

In general it is not necessary to use inert gas blanketing for the vessels; in certain embodiments, however, it may be desired. Examples of suitable inert gases include, but are not limited to, nitrogen, argon, hydrogen, and mixtures thereof. The sources of inert gases can be one or more conduits, pipelines, storage facilities, or cylinders. Inert gases can be supplied from a pipeline, cylinder, storage facility, cryogenic separation unit, membrane permeation separator, or adsorption unit such as a vacuum swing adsorption unit.

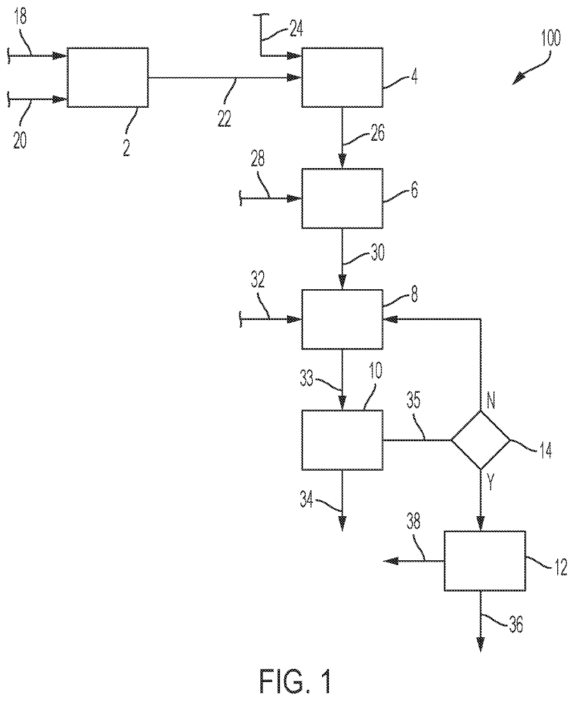

Referring now to the drawing figures, FIG. 1 is a high-level schematic process flow diagram of one process and system embodiment 100 in accordance with the present disclosure, including a vessel 2, an optional organic solvent washer 4, an optional inorganic salt solution washer 6, a water wash vessel 8, an optional centrifuge or shaker 10, and an optional filter 12. In certain embodiments some (or all) of these vessels or stages can be combined. A solid phase precursor non-nanoparticle material 18 (for example solid TiO₂, TiN, TIC, Si₃N₄, and MgO as described in the Examples herein) is routed to vessel 2, and an onium salt solution as well, 20. After raising the temperature and holding for a time as described in the Examples, vessel 2 produces a nanoparticle composition 22 which is optionally routed to organic solvent washer 4, as is an organic solvent 24. From optional organic solvent washer 4, a nanoparticle composition with reduced water 26 is produced which can be routed to optional vessel 6, along with an optional inorganic salt solution 28 (for example a 1 M aqueous solution of LiCl). Optional vessel 6 and the optional inorganic salt can be used to further cleanse the nanoparticles. Nanoparticles 30 are then routed to vessel 8 for filling with water 32, and then through a conduit 33 to a centrifuge or shaker 10, where waste liquids and solids are removed (at 34). The supernatant fluid 35 is viewed (14) either by human or machine vision, or both, and if clear (Y) no more centrifuging or shaking is required, but if the supernatant is not clear (N), centrifuging or shaking is repeated until the supernatant is clear. A final water filled suspension of nanoparticles is then routed to a filter 12, forming a “filtered film” of nanoparticles 36 and a waste stream 38.

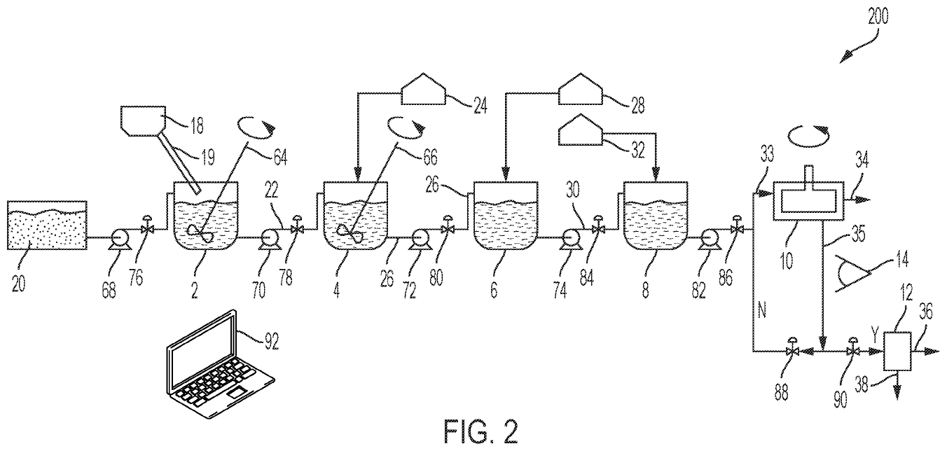

FIG. 2 is a more detailed schematic process flow diagram of another process and system embodiment 200 in accordance with the present disclosure. Embodiment 200 differs from embodiment 100 in that stirrers or agitators 64, 66 are included in vessel 2 and optional organic solvent washer 4, respectively, as well as various pumps and control valves, and a chute 19 for transfer of solid phase precursor non-nanoparticle material into vessel 2. Pump 68 transfers an aqueous onium solution 20 to vessel 2; pump 70 transfers nanoparticles from vessel 2 to optional organic solvent washer 4; pump 72 transfers nanoparticles from optional organic solvent washer 4 to optional vessel 6 for optional contact with an inorganic salt solution 28; pump 74 transfers the nanoparticles to water filling vessel 8, where additional water is added for centrifuging or shaking and the material is routed by pump 82 to centrifuge or shaker 10. After the supernatant is clear, as viewed by human or machine vision at 14, the nanoparticles are routed to filter 12. A series of control valves 76, 78, 80, 84, 86, 88, and 90 (some of which are optional) control flows from pumps 68, 70, 72, 74, and 82, respectively, controlled by one or more supervisory controllers 92 (such as a supervisory computer) that can operate via wired or wireless control signals to operate the control valves, pumps, agitators, and other equipment. It will be understood by those skilled in the chemical processing arts that many variations of embodiment 200 are possible. Furthermore, many sensors are not displayed that would be included in certain industrial embodiments, such as mass flow sensors or meters, temperature sensors, pressure sensors, pH sensors, weight sensors, and the like. One or more of these sensors or meters could be controllers as well, such as temperature-indicating-controllers, pressure-indicating controllers, and the like. These sensors are not illustrated in FIG. 2 for brevity.

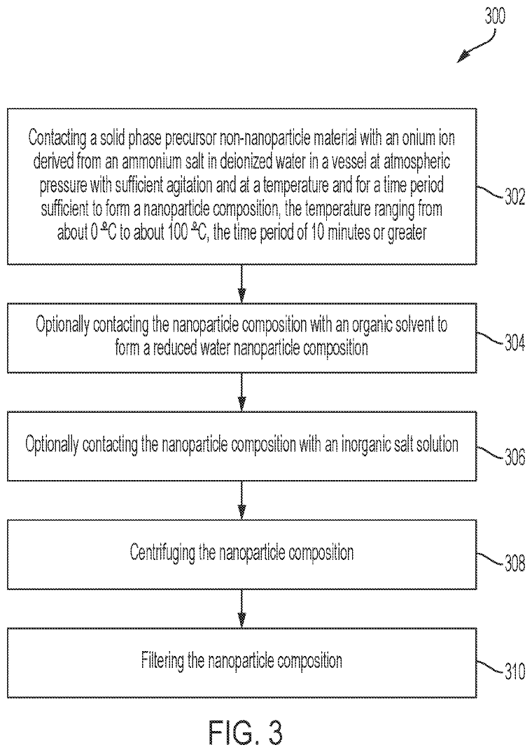

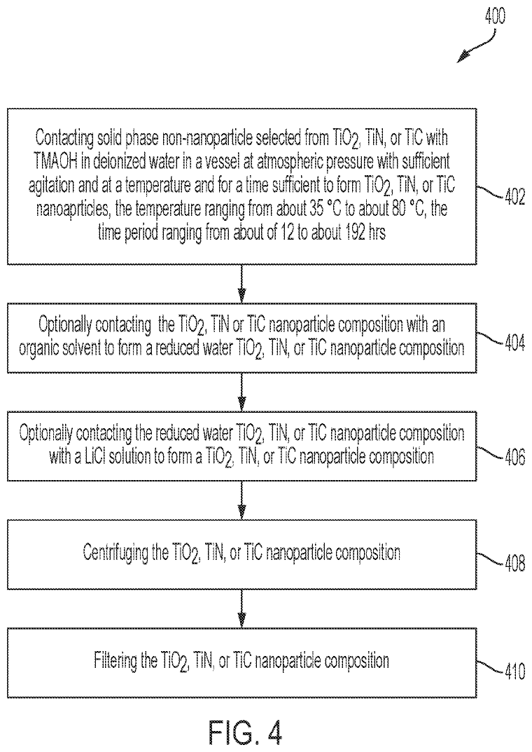

FIGS. 3 and 4 are logic diagrams of two process embodiments 300, 400 in accordance with the present disclosure. Process embodiment 300 includes contacting a solid phase precursor non-nanoparticle material with an onium ion derived from an ammonium salt in deionized water in a vessel at atmospheric pressure with sufficient agitation and at a temperature and for a time sufficient to form a nanoparticle composition, the temperature ranging from about 0° C. to about 100° C., the time period of 10 minutes or greater, box 302. Process embodiment 300 further includes optionally contacting the nanoparticle composition with an organic solvent to form a reduced water nanoparticle composition, box 304, followed optionally by contacting the reduced water nanoparticle composition with an inorganic salt solution, box 306. Process embodiment 300 continues with centrifuging, box 308, and filtering the nanoparticle composition, box 310.

Process embodiment 400 includes contacting a solid phase precursor non-nanoparticle TiO₂, TiN, or TiC with tetramethylammonium hydroxide (TMAOH) in deionized water in a vessel at atmospheric pressure with sufficient agitation and at a temperature and for a time sufficient to form TiO₂, TiN, or TiC nanoparticles, the temperature ranging from about 35° C. to about 80° C., the time ranging from about 12 hrs. to about 192 hrs., box 402. Process embodiment 400 further optionally includes contacting the TiO₂, TiN, or TiC nanoparticle composition with an optional organic solvent to form a reduced water TiO₂, TiN, or TiC nanoparticle composition, box 404, followed optionally by contacting the reduced water TiO₂, TiN, or TiC nanoparticle composition with a LiCl solution to form a TiO₂, TiN, or TiC nanoparticle composition, box 406. Process embodiment 400 continues with centrifuging, box 408, and filtering the TiO₂, TiN, or TiC nanoparticle composition, box 410.

Thus the systems and processes described herein, and equivalents thereof afford ways to produce nanoparticles safely and economically from non-nano source materials. The following Examples may further assist in understanding certain aspects of the systems and processes of this disclosure.

### EXAMPLES

### Experimental Details

Table 1 lists all the precursors and chemicals used in this work. Table 2 summarizes processing conditions used for all the runs. “TMAOH” refers to tetramethyl ammonium hydroxide. “TBAOH” refers to tetrabutylammonium hydroxide.

After reaction of the solid phase precursor with the onium salt, a black (except when the precursor was TiO₂) dark mud was obtained, collected and rinsed with ethanol, shook, and centrifuged at 3500 rpm for multiple cycles until a clear supernatant was obtained. Once the supernatant was clear, 40 mL of deionized, DI, water was added to the washed products, shook for 5 mins. After centrifugation at 3500 rpm for 0.5 h, without sonication, a stable dark (in most cases) nanoparticle composition was obtained. Any unreacted powders settled down. The nanoparticle composition was then vacuum filtered to produce filtered films, FF, some of which were characterized.

For reasons discussed further herein, most of the characterization was carried out on LiCl washed films. A 5M LiCl solution was added to the black nanoparticle compositions. This resulted in suspension's deflocculation. The sediment was shaken and rinsed with deionized water through centrifugation at 5000 rpm for three cycles. The LiCl/DI water washing process was repeated until the pH was ≈7. The washed sediment was then sonicated in a cold bath for 1 h under flowing Ar, shaken for 5 min, then centrifuged at 3500 rpm for 0.5 h. The nanoparticle composition was filtered to produce FFs (filtered films). Note that using a diluted solution of NaOH, KOH, or KF also led to deflocculation. The FFs were then left to dehydrate in a vacuum chamber overnight before further characterization.

### X-Ray Diffraction, XRD

XRD patterns on wet and dry samples were acquired using a powder diffractometer (Rigaku SmartLab) setup in the Bragg-Brentano geometry with Cu Kα radiations in the 2-65° 2θ range using a 0.02° step size and a dwell time of 1 s/step.

### X-Ray Photoelectron Spectroscopy, XPS

XPS was performed using a spectroscope (VersaProbe 5000, Physical Electronics, Chanhassen, Minnesota). Monochromatic Al-Kα X-rays with 200 μm spot size were used for analysis. A pass energy of 23.5 eV was used for all scans, with an energy step of 0.05 eV, and a step time of 0.5 s was used to gather the high-resolution spectra. The number of repeats per scan was set to 10. The XPS spectra were calibrated by setting the C-C peak to 285.0 eV. The peaks were fit using asymmetric Gaussian/Lorentzian line shape. The background was determined using the Shirley algorithm. All samples were mounted on the XPS stage using carbon tape.

### Scanning Electron Microscope, SEM

Micrographs and elemental compositions were obtained using a SEM, (Zeiss Supra 50 VP, Carl Zeiss SMT AG, Oberkochen, Germany), equipped with an energy-dispersive X-ray spectroscope (EDS, Oxford EDS, Oxfordshire, United Kingdom).

TABLE 1
Sources of powders and reagents and refs.

| | | | |
|---|---|---|---|
| | | | Precursor |
| | | | Inventory |
| Precursor | Source | Specifications | No. |

Precursors
Ti compounds

| | | | |
|---|---|---|---|
| TiO₂ | Aldrich | 99.7%, <25 nm | 637254- |
| | | | 100G |
| TiC | Alfa Aesar | 99.5%, >2 μm | 40178 |
| TiN | Alfa Aesar | 99.7%, −325 mesh | 14510 |

Fe compounds

| | | | |
|---|---|---|---|
| FeB | Alfa Aesar | 98%, −400 mesh | 88146 |
| Fe₃O₄ | Spectrum | Ferrosoferric oxide | F1058- |
| | | | 500G |

Si compound

| | | | |
|---|---|---|---|
| SiO₂ | Alfa Aesar | Amorphous SiO₂, −325, 99.0% | 89709 |
| α-Si₃N₄ | Alfa Aesar | 99.9%, <1 μm | 14704 |
| β-Si₃N₄ | Alfa Aesar | 99.9%, <1 μm | 14704 |

Mg compound

| | | | |
|---|---|---|---|
| MgO | Alfa Aesar | 99.95%, chunks | 14648 |

Reagents

| | | | |
|---|---|---|---|
| TMAOH | Alfa Aesar | (CH₃)₄NOH, 25 wt % in water, | 20932 |
| | | 99.9999% | |
| TBAOH | Alfa Aesar | [CH₃(CH₂)₃]₄NOH, 40 w/w aq. | |
| | | solution | |
| LiCl | Alfa Aesar | Anhydrous, 99%, −20 mesh | |
| H₂O₂ | Alfa Aesar | 35 wt. % in water | |
| Ethanol | DECON Lab | Pure 200 Proof | |
| | Inc. | | |
| DI water | Home-unit | 18.2 MΩ | |

TABLE 2
Summary of starting mixture, synthesis, and processing conditions.

| | Starting mixture | | | Nanoparticle size (Å) | | |
|---|---|---|---|---|---|---|
| Pre- | Metal:Reagent | Synth. | Processing and product | | Std. | Resulting |
| cursor | mole ratio | Cond. | obtained | Avg. | Dev. | Product |

Ti Compounds

| | | | | | | | |
|---|---|---|---|---|---|---|---|
| 1 | TiO₂ | 1 g TiO₂, | 35° C. | Water and LiCl wash. | 75 | 4 | Anatase |
| | | 10 mL TMAOH | 144 h | Filtered film. | | | |
| | | (0.43) | | | | | |
| 2 | TiO₂ | 1 g TiO₂, | 50° C. | Water and LiCl wash. | 151 | 32 | Anatase |
| | | 10 mL TMAOH | 96 h | Filtered film. | | | |
| | | (0.43) | | | | | |
| 3 | TiO₂ | 1 g TiO₂, | 80° C. | Water and LiCl wash. | 103 | N/A | Anatase |
| | | 10 mL TMAOH | 48 h | Filtered film. | | | |
| | | (0.43) | | | | | |
| 4 | TiO₂ | 1 g TiO₂, | 80° C. | Water and LiCl wash. | 104 | 4 | Anatase |
| | | 10 mL TMAOH | 48 h | Filtered film + 3 h at | | | |
| | | (0.43) | | 200° C. in air | | | |
| 5 | TiO₂ | 1 g TiO₂, | 35° C. | Water and LiCl wash. | 114 | 10 | Anatase |
| | | 10 mL TMAOH | 144 h | Filtered film + 3 h at | | | |
| | | (0.43) | | 200° C. in Ar | | | |
| 6 | TiO₂ | 1 g TiO₂, | 35° C. | Water and LiCl wash. | 522 | N/A | Anatase |
| | | 10 mL TMAOH | 144 h | Filtered film + 3 h at | | | |
| | | (0.43) | | 800° C. in Ar | | | |
| 7 | TiO₂ | 1 g TiO₂, | 35° C. | Water and LiCl wash. | 136 | 42 | Anatase |
| | | 10 mL TMAOH | 144 h | Colloidal suspension | | | |
| | | (0.43) | | Filtered film | | | |
| 8 | TiO₂ | 1 g TiO₂, | 50° C. | Water and LiCl wash. | 118 | 73 | Anatase |
| | | 10 mL TMAOH | 96 h | Colloidal suspension | | | |
| | | (0.43) | | Filtered film | | | |
| 9 | TiO₂ | 1 g TiO₂, | 80° C. | Water and LiCl wash. | 111 | 16 | Anatase |
| | | 10 mL TMAOH | 48 h | Filtered film + 3 h at | | | |
| | | (0.43) | | 800° C. in Ar | | | |
| 10 | TiO₂ | 1 g TiO₂, | 35° C. | Water and LiCl wash. | 96 | 24 | Anatase |
| | | 10 mL TMAOH | 144 h | Filtered film + 3 h at | | | |
| | | (0.43) | | 200° C. in Ar | | | |
| 11 | TiC | 0.5 g TiC, | 80° C. | Water and LiCl wash. | 200 | 8 | Anatase |
| | | 10 mL TBAOH | 12 h | Filtered powder - DMF | | | |
| | | (1.09) | | | | | |
| 12 | TiC | 0.5 g TiC, | 80° C. | Water and LiCl wash. | 292 | 13 | Anatase |
| | | 10 mL TBAOH | 12 h | Filtered powder - DMF | | | |
| | | (1.09) | | | | | |
| 13 | TiC | 0.5 g TiC, | 80° C. | Water and LiCl wash. | 210 | 15 | Anatase |
| | | 10 mL TBAOH | 12 h | Filtered powder | | | |
| | | (1.09) | | | | | |
| 14 | TiC | 0.5 g TiC, | 80° C. | Water and LiCl washing | 4 | 1 | TiC |
| | | 10 mL TMAOH | 120 h | Filtered film | | | |
| | | (0.6) | | | | | |
| 15 | TiN | 1 g TiN, | 50° C. | Ethanol and water | 841 | 143 | TiN |
| | | 10 mL TBAOH | 192 h | washing | | | |
| | | (1.06) | | Colloidal suspension | | | |
| | | | | Filtered film | | | |
| 16 | TiN | 2.1 g TiN, | 80° C. | Ethanol washing | 1511 | 816 | TiN |
| | | 20 mL TMAOH | 24 h | Filtered powder | | | |
| | | (0.6) | | | | | |
| 17 | TiN | 2.1 g TiN, | 80° C. | Ethanol washing | 846 | 690 | TiN |
| | | 20 mL TMAOH | 120 h | Filtered powder | | | |
| | | (0.6) | | | | | |
| 18 | TiN | 1 g TiN, | 50° C. | Ethanol and water | 72 | N/A | TiN |
| | | 10 mL TMAOH | 192 h | washing | | | |
| | | (1.06) | | Filtered film | | | |
| 19 | TiB₂ | 1.17 g TiB₂, | 80° C. | Ethanol washing | 226 | 1 | TiB₂ |
| | | 10 mL TMAOH | 48 h | Filtered powder | | | |
| | | (0.6) | | | | | |
| 20 | TiB₂ | 1.17 g TiB₂, | 80° C. | Ethanol washing | 2894 | N/A | TiB₂ |
| | | 10 mL TMAOH | 48 h | Filtered powder | | | |
| | | (0.6) | | | | | |

Si Compounds

| | | | | | | | |
|---|---|---|---|---|---|---|---|
| 23 | SiO₂ | 1 g SiO₂, | 80° C. | Water and LiCl wash | 64 | N/A | SiO₂ |
| | | 10 mL TMAOH | 48 h | Filtered powder | | | |
| | | (0.58) | | | | | |
| 24 | α- | 1 g α-Si₃N₄, | 50° C. | Water and LiCl wash | 439 | N/A | α-Si₃N₄, |
| | Si₃N₄ | 10 mL TMAOH | 144 h | Filtered film | | | |
| | | (2.47) | | | | | |
| 25 | β-Si₃N₄ | 1 β-Si₃N₄, | 50° C. | Water and LiCl wash | 379 | N/A | β-Si₃N₄ |
| | | 10 mL TMAOH | 144 h | Filtered film | | | |
| | | (2.47) | | | | | |

Mg Compounds

| | | | | | | | |
|---|---|---|---|---|---|---|---|
| 26 | MgO | 1 g MgO, | 80° C. | Water and LiCl wash | 561 | 122 | Mg(OH)₂ |
| | | 10 mL TMAOH | 144 h | Filtered powder | | | |
| | | (0.86) | | | | | |

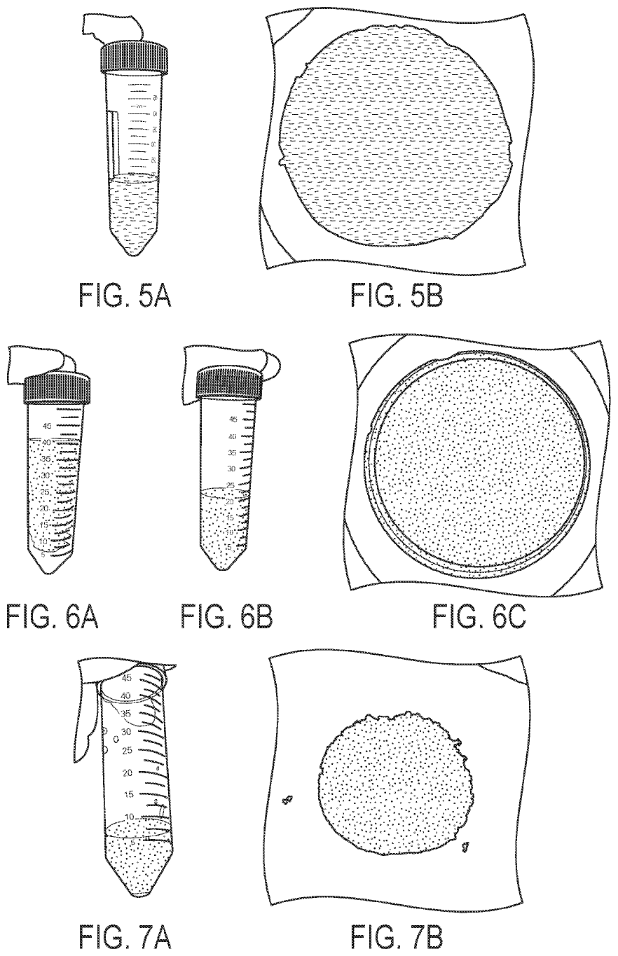

FIGS. 5A, 5B, 6A, 6B, 7A, and 7B are photographs of the laboratory experiments and nanoparticle compositions from the Examples in accordance with the present disclosure. FIG. 5A shows a suspension of nanoparticulate TiO₂, and FIG. 5B shows a filtered film of nanoparticulate TiO₂ formed by reacting non-nanoparticulate TiO₂ with TMAOH at 35° C. for 144 hrs., washed with ethanol, filled with DI water, centrifuged, then filtered. FIG. 6A shows a suspension of nanoparticulate TiC, FIG. 6B shows a suspension of nanoparticulate TiC, and FIG. 6C shows a filtered film of nanoparticulate TiC formed by reacting solid phase non-nanoparticulate TiC with TMAOH at 80° C. for 120 hrs., washed with ethanol, LiCl, shook, then filtered. FIG. 7A shows a suspension of FeB nanoparticles, and FIG. 7B shows a filtered film of nanoparticulate FeB formed by reacting solid phase non-nanoparticulate FeB with TMAOH at 50° C. for 48 h, washed with ethanol, filled with DI water, centrifuged, then filtered.

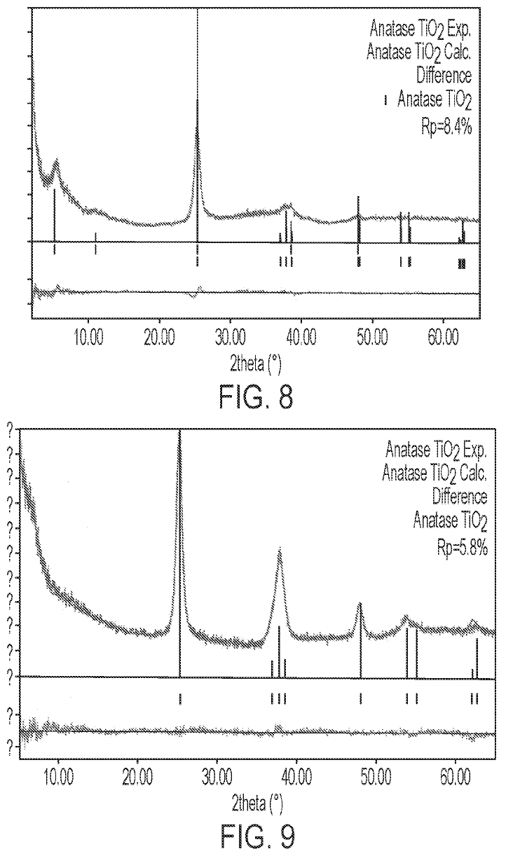

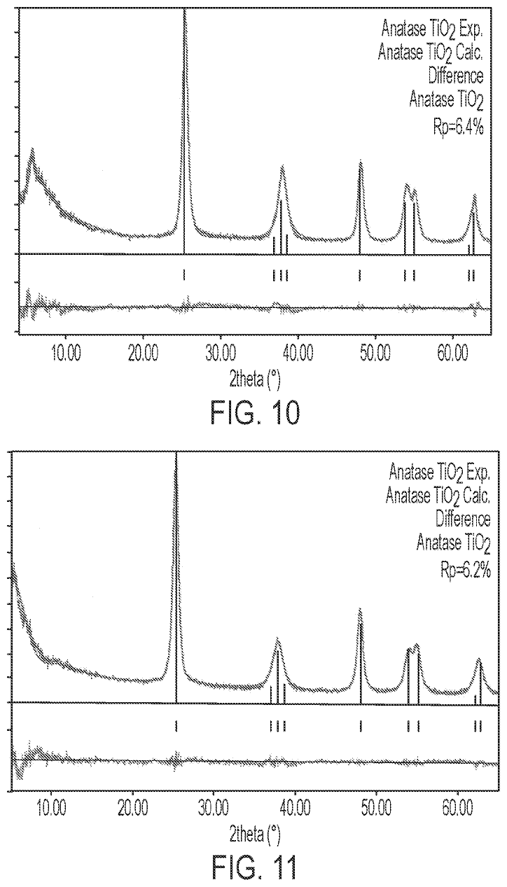

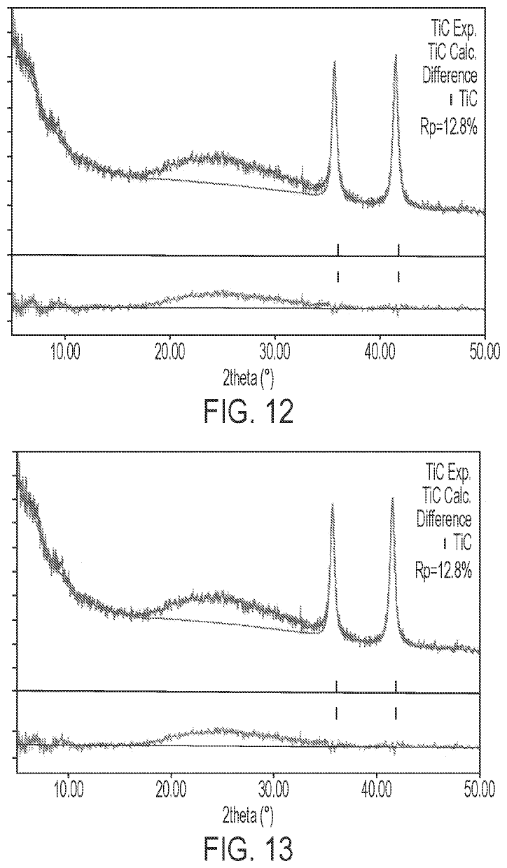

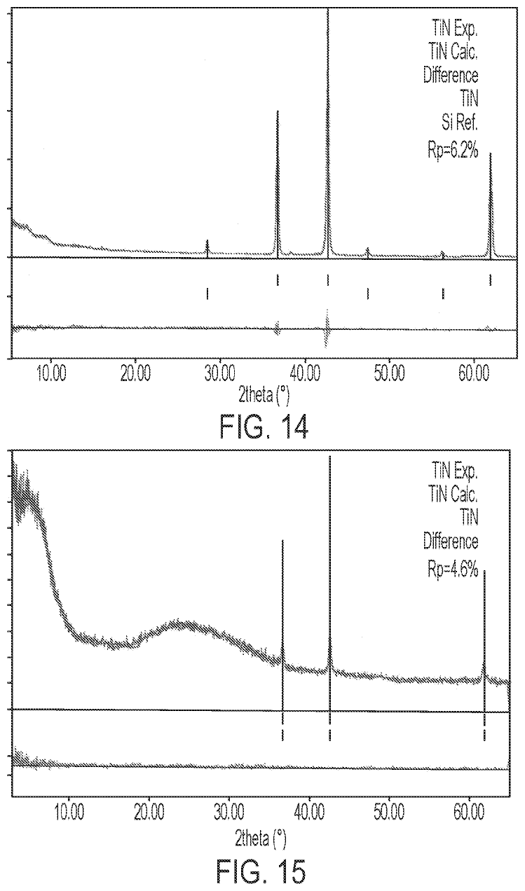

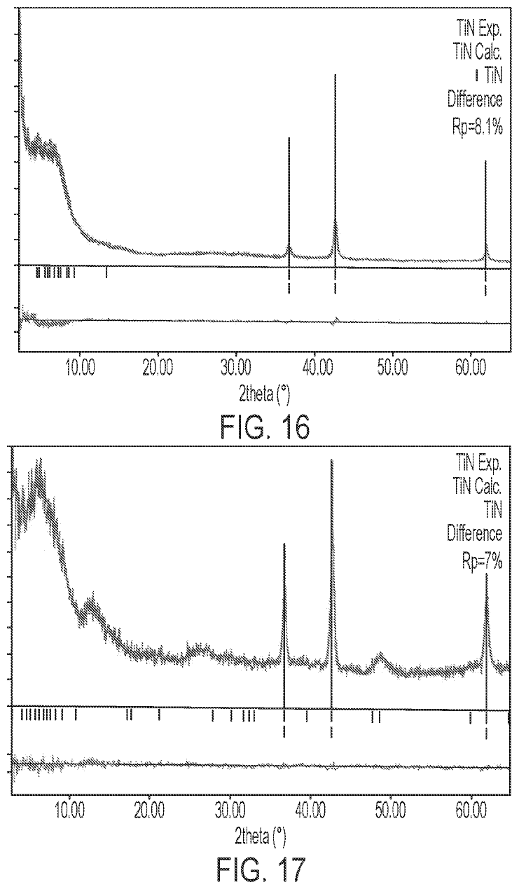

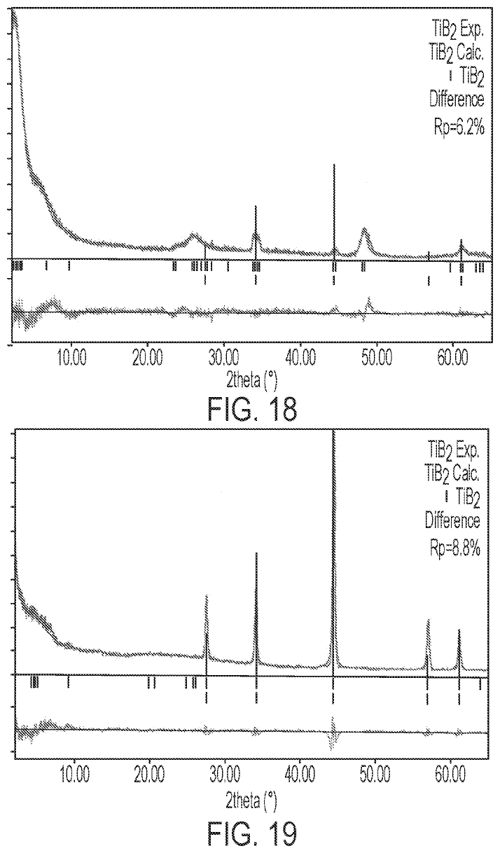

FIGS. 8, 9, 10, 11, 12, 13, 14, 15, 16, 17, 18, and 19 are the powder XRD graphs of the nanoparticle samples produced in accordance with Examples 7, 8, 9, 10, 11, 12, 15, 16, 17, 19, and 20, respectively. The broadening of at least some of the peaks verified the presence of nanoparticles.

We discovered a simple, inexpensive, relatively high-yield, near ambient, scalable, bottom-up approach to fabricate nanoparticles from solid phase precursor non-nanoparticles. That the starting solid phase non-nanomaterials are relatively inexpensive commodity will further fuel interest among the scientific community in these new nanoparticles.

Certain apparatus and process embodiments of this disclosure can be controlled by one or more controllers. For example, reaction temperature can be controlled by monitoring one or more parameters selected from temperature, mass and/or volume flow rate of reactants, temperature, mass and/or volume flow rate of the reaction products, and combinations thereof. Certain apparatus and processes of this disclosure can also measure and/or monitor feed rate of feed materials, such as precursor materials, onium, and water, and use these measurements for control purposes. Flow diverter positions can be adjusted or controlled to increase heat transfer in heat transfer substructures.

Various conduits, such as feedstock supply conduits, inert gas conduits, heat-transfer fluid supply and return conduits, as well as vessels of the present disclosure can be comprised of polymer (for example polyethylene) or polymer-lined metal or glass, or combination thereof.

The choice of a particular vessel or other component material is dictated among other parameters by the chemistry, pressure, and temperature of reactants used and type of nanoparticle to be produced with certain feedstocks, amount of nanoparticles produced, and the like. The skilled artisan, having knowledge of the particular application, pressures, temperatures, and available materials, will be able design the most cost effective, safe, and operable vessels, feedstock and product conduits for each particular application without undue experimentation.

### Aspects

The following Aspects are illustrative only and do not limit the scope of the present disclosure or the appended claims. It should be understood that the present technology can include a part of or all of any one of the following Aspects in any combination.

Aspect 1. A process, comprising: contacting a solid phase precursor (which can optionally be a non-nanoparticle) that comprises any one or more of: oxides of metals, oxides of metalloids, carbides of metals, carbides of metalloids, nitrides of metals, nitrides of metalloids, borides of metals, borides of metalloids, silicides of metals, silicides of metalloids, phosphides of metals, phosphides of metalloids, sulfides of metals, sulfides of metalloids, and mixtures thereof, with one or more onium ions derived from one or more onium salts, in water, in a vessel with sufficient agitation and at a temperature and for a time period sufficient to form nanoparticles, the temperature ranging from about 0° C. to about 100° C. for a time period of at least about 10 minutes, e.g., from about 10 minutes to about 144 hours and all intermediate values and sub-ranges.

Aspect 2. The process of Aspect 1 wherein the metals are selected from the group consisting of transition metals (the elements in Groups 3-12 of the Periodic Table) and mixtures and combinations thereof.

Aspect 3. The process of Aspect 2, wherein the transition metals are selected from the group consisting of Fe, Mn, Co and Ti, and mixtures and combinations thereof.

Aspect 4. The process of Aspect 1, wherein the metals are selected from the group consisting of one or more alkaline earth metals, and mixtures and combinations thereof.

Aspect 5. The process of Aspect 4 wherein the alkaline earth metal is Mg.

Aspect 6. The process of Aspect 1, wherein the metalloids are selected from the group consisting of Si, B, As, Ge, Sb, P, and Te, and mixtures and combinations thereof.

Aspect 7. A composition, comprising: nanoparticles produced by the process of Aspect 1, the nanoparticles having the same crystalline structure as the solid phase precursor as determined by XRD and/or TEM.

Aspect 8. The process of Aspect 1, wherein the contacting of the solid phase precursor non-nanoparticle with the one or more onium ions derived from one or more onium salts comprises contacting a material comprising Ti with the one or more onium ions derived from one or more onium salts.

Aspect 9. The process of Aspect 1, wherein the contacting of the solid phase precursor non-nanoparticle with the one or more onium ions derived from one or more onium salts comprises contacting a binary material with the one or more onium ions derived from one or more onium salts.

Aspect 10. The process of Aspect 9, wherein the contacting of the binary material with the one or more onium ions derived from one or more onium salts comprises contacting one or more of TiC, TiB₂, TIN, TiC, Si₃N₄, MgO, Ti₅S₃, TiAl₃, TiO₂, MnB, Mn₃O₄, Mn₂O₃, FeB, Fe₂O₃, ZrC, Si₃N₄, Co(OH)₂, and SiC or any mixture or combination thereof with the one or more onium ions derived from one or more onium salts.

Aspect 11. The process of Aspect 1, wherein the contacting of the solid phase precursor non-nanoparticle with the one or more onium ions derived from one or more onium salts comprises contacting an M-ternary material with the one or more onium ions derived from one or more onium salts.

Aspect 12. The process of Aspect 11, wherein the contacting of the M-ternary material with the one or more onium ions derived from one or more onium salts comprises contacting one or more of Ti₃AlC₂, Ti₃SiC₂, Ti₃GaC₂, Ti₂SbP, Mn₅SiB₂, Mn₂AlB₂, Fe₅SiB₂, Fe₂AlB₂, Zr₃AlC₅, V₂AlC, and Nb₂AlC, or any mixture or combination thereof with the one or more onium ions derived from one or more onium salts.

Aspect 13. The process of Aspect 1, wherein the contacting of the solid phase precursor non-nanoparticle with the one or more onium ions derived from one or more onium salts comprises contacting an MD-binary or MD-ternary material with the one or more onium ions derived from one or more onium salts.

Aspect 14. The process of Aspect 1, wherein the contacting of the solid phase precursor non-nanoparticle with the one or more onium ions derived from one or more onium salts comprises contacting a quaternary M-containing material that comprises more than one metal element with the one or more onium ions derived from one or more onium salts.

Aspect 15. The process of Aspect 1, wherein the contacting of the solid phase precursor non-nanoparticle with the one or more onium ions derived from one or more onium salts comprises contacting the solid precursor non-nanoparticle with:
(a) one or more of TMAOH, TEAOH, TPAOH, TBAOH, NH₄OH, or THAOH, or any combination thereof;
(b) one or more amine derivatives of one or more of TMAOH, TEAOH, TPAOH, TBAOH, NH₄OH, or THAOH, or any combination thereof; or
(c) any combination of (a) and (b).

Aspect 16. The process of Aspect 15, wherein the contacting of the solid phase precursor non-nanoparticle with the one or more onium ions derived from one or more onium salts comprises contacting the solid phase precursor non-nanoparticle with ammonium ions derived from TMAOH.

Aspect 17. The process of Aspect 15, wherein the contacting of the solid phase precursor non-nanoparticle with the one or more onium ions derived from one or more onium salts comprises contacting the solid phase precursor non-nanoparticle with ammonium ions derived from TBAOH.

Aspect 18. The process of Aspect 1, wherein the contacting of the solid phase precursor non-nanoparticle with the one or more onium ions derived from one or more onium salts comprises contacting the solid phase precursor non-nanoparticle with a composition comprising ammonium ions derived from TMAOH.

Aspect 19. The process of Aspect 1, wherein the temperature ranges from about 35° C. to about 80° C.

Aspect 20. The process of Aspect 1, wherein the metals are selected from the group consisting of Group 4, Group 5, Group 6, Group 7, Group 8, Group 9, Group 10, Group 11, and Group 12 metals, and mixtures and combinations thereof.

Aspect 21. The process of Aspect 20, wherein the metals are selected from the group consisting of Group 4 metals and mixtures and combinations thereof.

Aspect 22. The process of Aspect 20, wherein the metals are selected from the group consisting of Group 5 metals and mixtures and combinations thereof.

Aspect 23. The process of Aspect 20, wherein the metals are selected from the group consisting of Group 6 metals and mixtures and combinations thereof.

Aspect 24. The process of Aspect 20, wherein the metals are selected from the group consisting of Group 7 metals and mixtures and combinations thereof.

Aspect 25. The process of Aspect 20, wherein the metals are selected from the group consisting of Group 8 metals and mixtures and combinations thereof.

Aspect 26. The process of Aspect 20, wherein the metals are selected from the group consisting of Group 9 metals and mixtures and combinations thereof.

Aspect 27. The process of Aspect 20, wherein the metals are selected from the group consisting of Group 10 metals and mixtures and combinations thereof.

Aspect 28. The process of Aspect 20, wherein the metals are selected from the group consisting of Group 11 metals and mixtures and combinations thereof.

Aspect 29. The process of Aspect 20, wherein the metals are selected from the group consisting of Group 12 metals and mixtures and combinations thereof.

Aspect 30. The process of Aspect 15, wherein the metalloids are selected from the group consisting of Si, B, As, Ge, Sb, P, and Te, and mixtures and combinations thereof.

Aspect 31. The process of Aspect 1, wherein the process is a one-pot process, i.e., a process performed in a single vessel.

Aspect 32. A composition, comprising nanoparticles prepared according to the process of any one of Aspects 20 to 31.

Aspect 33. A composition, comprising: nanoparticles prepared according to the process of any one of Aspects 20 to 31 comprising a substantially anatase and/or substantially rutile structure.

The disclosed technology can also include any one or more of the following Elements.

Element 1: Processes wherein the metals are transition metals, the elements in Groups 3-12 of the Periodic Table.

Element 2: Processes wherein the transition metals are selected from Mn and Ti an Fe, Cr, Ni.

Element 3: Process wherein the metal is one or more alkaline earth metals.

Element 4: Process wherein the alkaline earth metal is Mg.

Element 5: Processes wherein the metalloid is selected from Si, B, As, Ge, Sb, P, and Te, and mixtures thereof.

Element 6: Processes wherein the contacting of the solid phase precursor non-nanoparticles with the one or more onium ion derived from one or more onium salts comprises contacting a material comprising Ti with the one or more onium ions derived from one or more onium salts.

Element 7: Processes wherein the contacting of the solid phase precursor non-nanoparticle with the one or more onium ions derived from one or more onium salts comprises contacting a binary material with the one or more onium ions derived from one or more onium salts.

Element 8: Processes wherein the contacting of the binary material with the one or more onium ions derived from one or more onium salts comprises contacting one or more of TiC, TiB₂, TIN, TiC, Si₃N₄, MgO, Ti₅S₃, TiAl₃, TiO₂, MnB, Mn₃O₄, FeB, Fe₂O₃, ZrC, Si₃N₄, and SiC or any mixture or combination thereof with the one or more onium ions derived from one or more onium salts.

Element 9: Processes wherein the contacting of the solid phase precursor non-nanoparticle with the one or more onium ions derived from one or more onium salts comprises contacting an M-ternary material with the one or more onium ions derived from one or more onium salts.

Element 10: Processes wherein the contacting of the M-ternary material with the one or more onium ions derived from one or more onium salts comprises contacting one or more of Ti₃AlC₂, Ti₃SiC₂, Ti₃GaC₂, Ti₂SbP, Mn₅SiB₂, Mn₂AlB₂, Fe₅SiB₂, Fe₂AlB₂, Zr₃AlC₅, V₂AlC, and Nb₂AlC, or any mixture or combination thereof with the one or more onium ions derived from one or more onium salts.

Element 11: Processes wherein the contacting of the solid phase precursor non-nanparticle with the one or more onium ions derived from one or more onium salts comprises contacting an MD-binary or MD-ternary material with the one or more onium ions derived from one or more onium salts.

Element 12: Processes wherein the contacting of the solid phase precursor non-nanoparticle with the one or more onium ions derived from one or more onium salts comprises contacting a quaternary M-containing material that comprises more than one metal element with the one or more onium ions derived from one or more onium salts.

Element 13: Processes wherein the contacting of the solid phase precursor non-nanoparticle material with the one or more onium ions derived from one or more onium salts comprises contacting the solid phase precursor non-nanoparticle material with: (a) one or more of TMAOH, TEAOH, TPAOH, TBAOH, NH₄OH, or THAOH, or any combination thereof; (b) one or more amine derivatives of one or more of TMAOH, TEAOH, TPAOH, TBAOH, NH₄OH, or THAOH, or any combination thereof; or (c) any combination of (a) and b).

Element 14: Processes wherein the contacting of the solid phase precursor non-nanoparticle material with the one or more onium ions derived from one or more onium salts comprises contacting the solid phase precursor non-nanoparticle material with TMAOH.

Element 15: Processes wherein the contacting of the solid phase precursor non-nanoparticle material with the one or more onium ions derived from one or more onium salts comprises contacting the solid phase precursor non-nanoparticle material with TBAOH.

Element 16: Processes wherein the contacting of the solid phase precursor non-nanoparticle material with the one or more onium ions derived from one or more onium salts comprises contacting the solid phase precursor non-nanoparticle material with an onium salt composition comprising TMAOH.

Element 17: Processes wherein the temperature ranges from about 35° C. to about 80° C.

Element 18: Processes wherein the metal is at least one Group 4, Group 5, Group 6, Group 7, Group 8, Group 9, Group 10, Group 11, or Group 12 metal.

Element 19: Processes wherein the metal is at least one Group 4 metal.

Element 20: Processes wherein the metal is at least one Group 5 metal.

Element 21: Processes wherein the metal is at least one Group 6 metal.

Element 22: Processes wherein the metal is at least one Group 7 metal.

Element 23: Processes wherein the metal is at least one Group 8 metal.

Element 24: Processes wherein the metal is at least one Group 9 metal.

Element 25: Processes wherein the metal is at least one Group 10 metal.

Element 26: Processes wherein the metal is at least one Group 11 metal.

Element 27: Processes wherein the metal is at least one Group 12 metal.

Element 28: Compositions prepared according to the processes of any one of Elements 1-27.

Element 29: Compositions prepared according to the processes of any one of Elements 1-27 having an anatase-like and/or rutile-like structure.

Element 30: Processes where the production of nanoparticles is a one-pot process.

Although only a few exemplary embodiments of this disclosure have been described in detail above, those skilled in the art will readily appreciate that many modifications are possible in the exemplary embodiments without materially departing from the novel teachings and advantages of this disclosure, and these modifications are considered further Elements in accordance with the previous paragraph that can be combined with all other embodiments.

For example, the vessels and processes described herein can be batch, semi-batch, continuous, or combination thereof in any particular embodiment (for example, a first batch vessel where a first batch of nanoparticles is produced, followed by a second vessel operated continuously to produce a second nanoparticle composition). One, two, or more than two different solid phase non-nanoparticle precursors can be used in a first vessel (for example a binary precursor in a first vessel, and a ternary precursor in a second vessel). Two or more than two different vessels can be arranged in parallel or series. Accordingly, all such modifications are intended to be included within the scope of this disclosure as defined in the following claims.

In the claims, no clauses are intended to be in the means-plus-function format allowed by 35 U.S.C. § 112, Section F, unless “means for” is explicitly recited together with an associated function. “Means for” clauses are intended to cover the structures, materials, and/or acts described herein as performing the recited function and not only structural equivalents, but also equivalent structures.

1. A process, comprising:
contacting a solid phase precursor non-nanoparticle that comprises any one or more of: oxides of metals, oxides of metalloids, carbides of metals, carbides of metalloids, nitrides of metals, nitrides of metalloids, borides of metals, borides of metalloids, silicides of metals, silicides of metalloids, sulfides of metals, sulfides of metalloids, phosphides of metals, phosphides of metalloids, and mixtures thereof, with one or more onium ions derived from one or more onium salts, in water, in a vessel with sufficient agitation and at a temperature and for a time period sufficient to form nanoparticles, the temperature ranging from about 0° C. to about 100° C. for a time period of at least 10 minutes.

2. The process of claim 1, wherein the metals are selected from the group consisting of transition metals and mixtures and combinations thereof.

3. The process of claim 2, wherein the transition metals are selected from the group consisting of Fe, Mn, Co and Ti, and mixtures and combinations thereof.

4. The process of claim 1, wherein the metals are selected from the group consisting of one or more alkaline earth metals, and mixtures and combinations thereof.

5. (canceled)

6. The process of claim 1, wherein the metalloids are selected from the group consisting of Si, B, As, Ge, Sb, P, and Te, and mixtures and combinations thereof.

7. A composition, the composition comprising nanoparticles produced by the process of claim 1 having the same crystalline structure as the solid phase precursor non-nanoparticle as determined by XRD and/or TEM.

8. The process of claim 1, wherein the contacting of the solid phase precursor non-nanoparticle with the one or more onium ions derived from one or more onium salts comprises contacting a material comprising Ti with the one or more onium ions derived from one or more onium salts.

9. The process of claim 1, wherein the contacting of the solid phase precursor non-nanoparticle with the one or more onium ions derived from one or more onium salts comprises contacting a binary material with the one or more onium ions derived from one or more onium salts.

10. The process of claim 9, wherein the contacting of the binary material with the one or more onium ions derived from one or more onium salts comprises contacting one or more of TiC, TiB₂, TiN, TiC, Si₃N₄, MgO, Ti₅S₃, TiAl₃, TiO₂, MnB, Mn₃O₄, Mn₂O₃, FeB, Fe₂O₃, ZrC, Si₃N₄, Co(OH)₂, and SiC or any mixture or combination thereof with the one or more onium ions derived from one or more onium salts.

11. The process of claim 1, wherein the contacting of the solid phase precursor non-nanoparticle with the one or more onium ions derived from one or more onium salts comprises contacting an M-ternary material with the one or more onium ions derived from one or more onium salts.

12. The process of claim 11, wherein the contacting of the M-ternary material with the one or more onium ions derived from one or more onium salts comprises contacting one or more of Ti₃AlC₂, Ti₃SiC₂, Ti₃GaC₂, Ti₂SbP, Mn₅SiB₂, Mn₂AlB₂, Fe₅SiB₂, Fe₂AlB₂, Zr₃AlC₅, V₂AlC, and Nb₂AlC, or any mixture or combination thereof with the one or more onium ions derived from one or more onium salts.

13. The process of claim 1, wherein the contacting of the solid phase precursor non-nanoparticle with the one or more onium ions derived from one or more onium salts comprises contacting an MD-binary or MD-ternary material with the one or more onium ions derived from one or more onium salts.

14. The process of claim 1, wherein the contacting of the solid phase precursor non-nanoparticle with the one or more onium ions derived from one or more onium salts comprises contacting a quaternary M-containing material that comprises more than one metal element with the one or more onium ions derived from one or more onium salts.

15. The process of claim 1, wherein the contacting of the solid phase precursor non-nanoparticle with the one or more onium ions derived from one or more onium salts comprises contacting the solid precursor non-nanoparticle with:
a) one or more of TMAOH, TEAOH, TPAOH, TBAOH, NH₄OH, or THAOH, or any combination thereof;
b) one or more amine derivatives of one or more of TMAOH, TEAOH, TPAOH, TBAOH, NH₄OH, or THAOH, or any combination thereof; or
c) any combination of a) and b).

16. The process of claim 15, wherein the contacting of the solid phase precursor non-nanoparticle with the one or more onium ions derived from one or more onium salts comprises contacting the solid phase precursor non-nanoparticle with ammonium ions derived from TMAOH or from TBAOH.

17. (canceled)

18. The process of claim 1, wherein the contacting of the solid phase precursor non-nanoparticle with the one or more onium ions derived from one or more onium salts comprises contacting the solid phase precursor non-nanoparticle with a composition comprising ammonium ions derived from TMAOH.

19. The process of claim 1, wherein the temperature ranges from about 35° C. to about 80° C.

20. The process of claim 1, wherein the metals are selected from the group consisting of Group 4, Group 5, Group 6, Group 7, Group 8, Group 9, Group 10, Group 11, and Group 12 metals, and mixtures and combinations thereof.

21. The process of claim 20, wherein the metals are selected from the group consisting of Group 4 metals and mixtures and combinations thereof.

22. The process of claim 20, wherein the metals are selected from the group consisting of Group 5 metals and mixtures and combinations thereof.

23. The process of claim 20, wherein the metals are selected from the group consisting of Group 6 metals and mixtures and combinations thereof.

24. The process of claim 20, wherein the metals are selected from the group consisting of Group 7 metals and mixtures and combinations thereof.

25. The process of claim 20, wherein the metals are selected from the group consisting of Group 8 metals and mixtures and combinations thereof.

26. The process of claim 20, wherein the metals are selected from the group consisting of Group 9 metals and mixtures and combinations thereof.

27. The process of claim 20, wherein the metals are selected from the group consisting of Group 10 metals and mixtures and combinations thereof.

28. The process of claim 20, wherein the metals are selected from the group consisting of Group 11 metals and mixtures and combinations thereof.

29. The process of claim 20, wherein the metals are selected from the group consisting of Group 12 metals and mixtures and combinations thereof.

30. The process of claim 15, wherein the metalloids are selected from the group consisting of Si, B, As, Ge, Sb, P, and Te, and mixtures and combinations thereof.

31. The process of claim 1, wherein the process is a one pot process.

32. A composition, the composition comprising nanoparticles prepared according to the process of claim 20.

33. (canceled)
